(19) United States
(12) Patent Application Publication
(10) Pub. No.: US 2005/0120340 A1
(43) Pub. Date: Jun. 2, 2005

(54) Apparatus, system, and method for automated generation of embedded systems software

(76) Inventors: Joseph G. Skazinski, Berthoud, CO (US); Keith E. Short, LaFayette, CO (US)

Correspondence Address: KUNZLER & ASSOCIATES, 8 EAST BROADWAY, SALT LAKE CITY, UT, 84111, US

(21) Appl. No.: 10/937,117

(22) Filed: Sep. 9, 2004

Related U.S. Application Data
(60) Provisional application No. 60/526,050, filed on Dec. 1, 2003.

(51) Int. Cl. G06F 9/45

(52) U.S. Cl. 717/140

(57) ABSTRACT

The apparatus includes an input module for receiving hardware description data. The hardware description data describes hardware components of an embedded system. The apparatus also includes a build module for generating a board support layer for interfacing with the hardware components. The system may include the apparatus, an automation server coupled to a communications network, and a graphical user interface configured to display selectable icons representative of hardware elements from a plurality of hardware element icons, organize the selected icons into a hardware design, and generate hardware description data from the hardware design. The method includes receiving hardware description data describing hardware components of an embedded system, generating an embedded system board support layer in response to the described hardware description data for interfacing with the hardware components, and compiling the embedded system board support layer into executable code.

### CROSS-REFERENCES TO RELATED APPLICATIONS

This application claims benefit of U.S. Provisional Patent Application No. 60/526,050 entitled “APPARATUS, SYSTEM, AND METHOD FOR AUTOMATED GENERATION OF EMBEDDED SYSTEMS SOFTWARE” and filed on Dec. 1, 2003 for Joseph G. Skazinski, which is incorporated herein by reference.

### BACKGROUND OF THE INVENTION

1. Field of the Invention

This invention relates to embedded systems and more particularly relates to automatic generation of a board support layer for custom embedded systems as well as the automatic customization of drivers and application software for the embedded system.

2. Description of the Related Art

Most embedded systems comprise a combination of hardware and software. The hardware may include a processor on a printed circuit board with a number of different integrated circuits wired together using some bus architecture such as Peripheral Component Interconnect (PCI) or VersaModule Eurocard bus (VME). These embedded systems can be highly customized to a particular form factor containing only the chips required for the successful completion of the final application.

The software, or board support layer (BSL) of an embedded system is an executable image having modules that enable an operating system to interface with hardware components of the embedded system. Due to the myriad of available hardware components, a customized BSL is required in order to match the particular nature of the hardware. In order to produce an executable image that can be programmed and executed on the target hardware, the BSL should be written based on the specific hardware of the target hardware design. The BSL should implement specific details such as buffer size, pinouts, chip type, chip manufacturer, and the like relating to the hardware. These details often change from one hardware design to the next, resulting in what is often called a software porting effort. The BSL should be revised to account for the hardware changes. A porting effort is typically required for each hardware revision.

One of the challenges facing embedded device vendors is building custom hardware and software that meets expected performance, cost and feature requirements. A major contributor to this challenge is the need to write new BSL software to enable and control custom hardware. Many final embedded designs often fall short of expectations in categories such as performance, functionality, and features due to the time constraints of working with new and complex custom hardware. Equally alarming, embedded device vendors that build custom software can suffer from project delays that may extend for many months. This delay is due in part to the sheer variety of board designs. A board design's processor, memory and bus architecture, and I/O peripherals can all vary considerably.

FIG. 1 is a schematic flow chart diagram illustrating one embodiment of a method 100 for developing a functional embedded system in accordance with the prior art. The method 100 starts 102 and an embedded system is first designed 104 with a specific purpose in mind. This design step determines which Integrated Circuits (ICs) will be used based on analyzing the many trade offs. The engineers then write 106 code for the BSL according to the hardware components chosen during the design 104 phase. Writing 106 the code for the BSL is a very time consuming and expensive stage in the development of the embedded system. Ultimately, the cost of writing and developing the BSL reduces the overall profit margins of a product. Once the BSL is written 106, the engineers then test the design using the BSL along with available hardware and hardware test software.

The engineers then build 108 and test 110 the embedded system. Frequently, engineers find that a chosen hardware component is not capable of functioning in a desired capacity. The engineers must then replace the component and modify the design and code, building a new prototype and testing that revision. Once the hardware is functioning properly, the method 100 ends 112. However, the simple act of replacing one type of memory for another may require a significant modification of the code for the BSL, thereby requiring additional effort and causing costly delays in the development of the embedded system.

From the foregoing discussion, it should be apparent that a need exists for an apparatus, system, and method that reduces the development effort for embedded system board support layers. Beneficially, such an apparatus, system, and method would automatically generate embedded system board support layers.

### SUMMARY OF THE INVENTION

The present invention has been developed in response to the present state of the art, and in particular, in response to the problems and needs in the art that have not yet been fully solved by currently available embedded system board support layers. Accordingly, the present invention has been developed to provide a process, apparatus, and system for generating embedded system board support layers that overcome many or all of the above-discussed shortcomings in the art.

The apparatus is provided with a logic unit containing a plurality of modules configured to functionally execute the necessary steps of automated generation of embedded system board support layers (BSL). These modules in the described embodiments include an input module configured to receive hardware description data describing hardware components of an embedded system, a build module configured to generate an embedded system board support layer in response to the hardware description data for interfacing with the hardware components, and a compiler module configured to compile the embedded system board support layer into executable code.

In one embodiment, the apparatus includes a modification module configured to link the embedded system board support layer and at least one component from a plurality of object code libraries to customize the executable code to specific hardware identified in the hardware description data. Additionally, the modification module may be configured to extract application specific software modules from predefined libraries. Furthermore, the build module may be configured to select source code from a platform library having pre-defined source code for hardware level communication with specific hardware identified in the hardware description data.

In a further embodiment, the apparatus may include an automation module configured to automatically identify hardware elements of an embedded system and generate hardware description data for the embedded system, and a graphical user interface configured to display selectable icons representative of hardware elements from a plurality of hardware element icons, organize the selected icons into a hardware design, and generate hardware description data from the hardware design. The input module may be configured to generate a hardware description markup language file from the hardware description data.

A system of the present invention is also presented for automated generation of BSL's. The system, in one embodiment, includes an automation server coupled to a communications network, an input module operatively coupled to the automation server and configured to receive hardware description data describing hardware components of an embedded system, and a build module configured to generate an embedded system board support layer in response to the hardware description data for interfacing with the hardware components. In a further embodiment, the system may include a compiler module configured to compile the embedded system board support layer into executable code, and a graphical user interface configured to display selectable icons representative of hardware elements from a plurality of hardware element icons, organize the selected icons into a hardware design, and generate hardware description data from the hardware design.

A method of the present invention is also presented for automated generation of BSL. The method in the disclosed embodiments substantially includes the steps necessary to carry out the functions presented above with respect to the operation of the described apparatus and system. In one embodiment, the method includes receiving hardware description data describing hardware components of an embedded system, generating an embedded system board support layer in response to the described hardware description data for interfacing with the hardware components, and compiling the embedded system board support layer into executable code.

The invention may also include an apparatus for automated generation of a BSL. The apparatus may include means for receiving hardware description data describing hardware components of an embedded system, means for generating an embedded system board support layer in response to the described hardware description data for interfacing with the hardware components, and means for compiling the embedded system board support layer into executable code.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic flow chart diagram illustrating one embodiment of a method for developing a functional embedded system in accordance with the prior art;

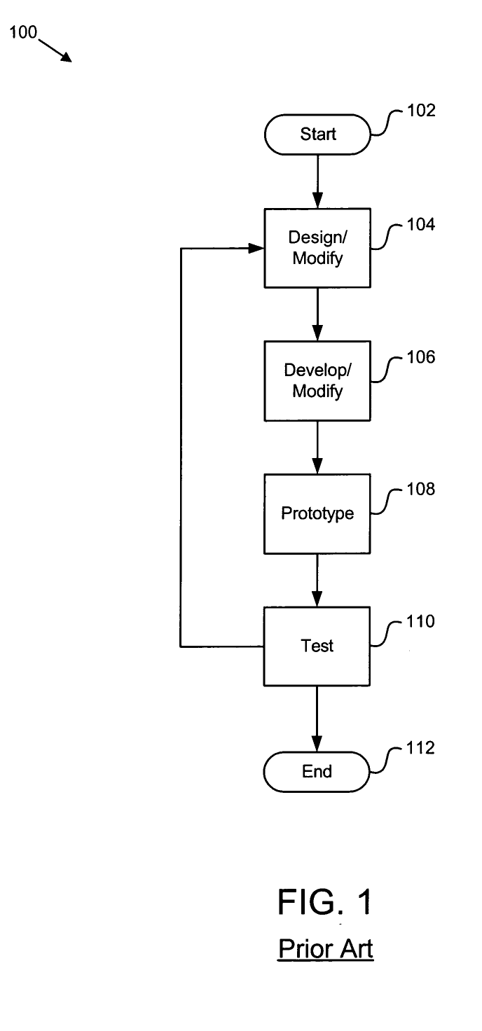

FIG. 2 is a schematic block diagram graphically illustrating one embodiment of a system for automated generation of embedded system software in accordance with the present invention;

FIG. 3 is a schematic block diagram illustrating one embodiment of an apparatus for automated generation of embedded systems software in accordance with the present invention;

FIG. 4 is a schematic block diagram illustrating one embodiment of representative layers of an embedded system in accordance with the present invention;

FIG. 5 is a schematic block diagram illustrating one embodiment of a graphical user interface for generating hardware description data in accordance with the present invention; and

FIG. 6 is a schematic flow chart diagram illustrating one embodiment of a method for automated generation of a board support layer in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

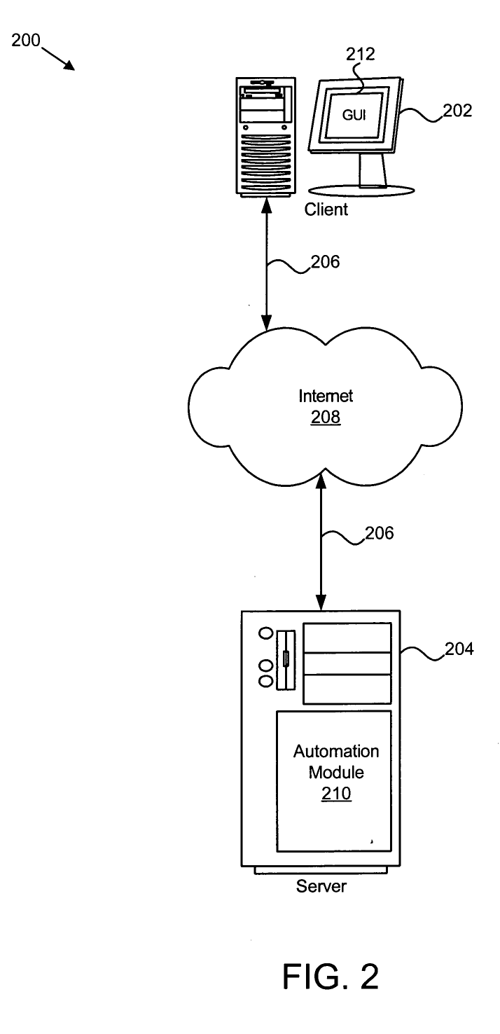

FIG. 2 illustrates a system 200 for automated embedded system software generation in accordance with the present invention. The system 200 may include a client device 202 and a server 204. In one embodiment, the client device 202 is a desktop computer. Alternatively, the client device 202 may comprise, but is not limited to, handheld devices, portable computers, servers, and mainframes. The client device 202 and the server 204 may be configured to communicate over a data communications network 206. In a further embodiment, the data communications network 206 may be coupled to a global communications network such as the Internet 208. Alternatively, the client device 202 and the server 204 may be operatively coupled on a common Local Area Network (LAN), Wide Area Network (WAN), Wireless Local Area Network (WLAN), or the like.

The server 204 includes an automation module 210 configured for automated embedded system software generation. The embedded system software may include a board support layer, which will be discussed in greater detail below. In one embodiment, the automation module 210 is configured to generate an executable board support layer (BSL) image suitable for controlling standard and customized embedded systems.

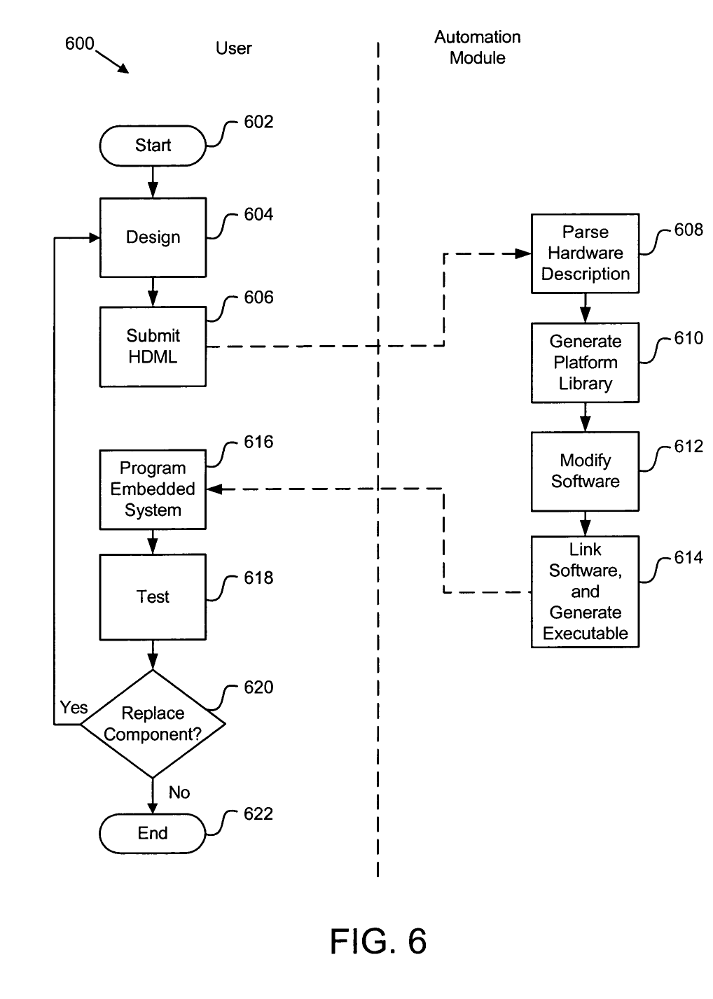

In a further embodiment, the client device 202 may include a graphical user interface (GUI) 212 configured to receive input from a user. The input may comprise hardware schematic figures, text files describing hardware components, binary files describing hardware components, or the like. The graphical user interface 212 may be configured to display a plurality of representative hardware component icons. The graphical user interface will be discussed below in greater detail with reference to FIG. 6.

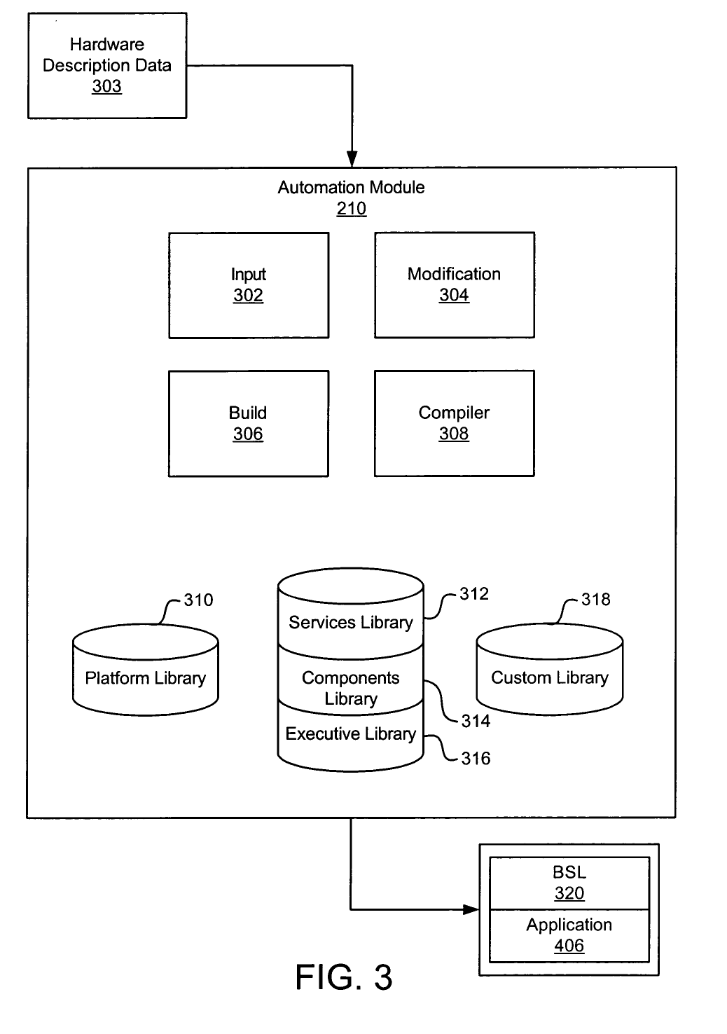

FIG. 3 is a schematic block diagram illustrating one embodiment of the automation module 210 in accordance with the present invention. The automation module 210 may include an input module 302, a modification module 304, a build module 306, and a compiler 308. In one embodiment, the input module 302 is configured to acquire hardware description data 303 for a particular embedded system. One example of hardware description data 303 is processor and component type information such as processor manufacturer, processor architecture, and bus architecture and width. Also, hardware description data 303 may include the type and size of on-board cache, the type and number of registers, types of arithmetic logic units included on the processor, and how each of the described components are connected. Alternatively, instead of acquiring the hardware description data 303, the input module 302 may be configured to receive the hardware description data from persistent storage.

The input module 302 may be configured to receive and interpret hardware description data 303 in a variety of formats including ASCI text, binary format, or a Hardware Description Markup Language (HDML) file. Typically, HDML files comprise eXtensible Markup Language (XML) code that include custom elements for communicating hardware specification data such as chip manufacture, chip model number, chip version number, and other hardware specific information.

In one embodiment, the input module 302 may be configured to receive hardware description data 303 over the Internet 208 (see FIG. 2). For example, an embedded systems designer may visit a website, access the graphical user interface 212, and select desired hardware components. The graphical user interface 212 may then generate an HDML file from the selected components. The graphical user interface 212 may also provide the HDML file to the input module 302. In a further embodiment of the same concept, the graphical user interface resides on a user's workstation and is used to create the hardware description data.

In a further embodiment, the input module 302 may be configured to gather hardware description data 303 through interfacing directly with the physical embedded system. Alternatively, the user may use a simple text-editing program to generate the HDML file. The resulting hardware description data 303 contains information such as platform and customer name, processor model and family, bus model and family, a list of all integrated components including their model and family, and address mapping information.

The input module 302 may be configured to receive third party hardware description data 303 formats from other software products such as Cadence® Verilog®, VHSIC Hardware Description Language (VHDL), and Synopsis®. Additionally, the input module 302 may be configured to input hypertext markup language (HTML) or XML documents. After successfully receiving the hardware description data 303, the input module 302 generates a hardware data structure which may be passed to the modification module 304. Various data structures may be used for the hardware data structure, including, but not limited to plain text, proprietary structures, HTML, XML, binary, graphical hardware maps, etc.

The modification module 304 is configured to customize a pregenerated platform library 310 according to the hardware data description 303 received from the input module 302. The platform library 310 may contain the software modules required to perform a basic low-level Input/Output (I/O) communication between the hardware components and any connected I/O devices, commonly refereed to as software drivers. These software modules serve as a foundation for higher-level software layers and libraries. The software modules may also perform basic operations such as hardware initialization, driver initialization, low level hardware component testing, and providing services required by higher level software such as operating systems and product specific applications.

In one embodiment, the modification module 304 customizes source files defining these software modules. The source files may contain information specific to a particular processor, bus architecture, or component. For example, the customized or modified source files may comprise header files, code modules, object archives and processor and memory specific initialization software. Preferably, the modified platform library 310 includes just the software necessary to operate basic I/O, initialization, and testing for the hardware components identified in the hardware data description 303. Alternatively, the modification module 304 may first create an empty data structure (not illustrated) and group the software modules into the empty data structure.

The build module 306 is configured to selectively extract source code from a plurality of libraries. The object code may be stored in object files. The libraries may include the previously modified platform library 310, a services library 312, a components library 314, an executive library 316, and a custom library 318. The services library 312 may contain software modules that use various hardware components, such as I/O ports, processors, and memory contained on the hardware platform to execute application level services. Examples of such services include, but are not limited to, data streaming, data encryption, data servers, network communication, video streaming, and communication with other devices.

The components library 314 may contain drivers, tests, and support for the various hardware chips and components used in the final embedded design. Preferably, code in the components library is native object code written for the specific make, model, and type of hardware. The components library 314 may also contain support modules for the processor, bus architecture, and other peripherals. Support modules may be configured to test the various hardware components for compatibility and conformance to published specifications or standards. For example, support modules may support the PCI and VME bus architectures, serial interfaces, and a wide array of memory devices including Flash, NVRAM, SRAM, and SDRAM.

The executive library 316 may contain operating system and user interface modules related to the final executable image. The custom library 318 may contain custom or proprietary software modules. The custom library 318 may contain source code for highly proprietary circuits such as a custom Application Specific Integrated Circuit (ASIC) and Field Programmable Gate-Arrays (FPGA). The build module 306 is configured to extract the necessary pieces from each library as directed by the hardware description data 303. Once extracted, the build module 306 converts the code extracted from each library into machine code by directing the compiler module 308 to perform the conversion.

The compiler 308 is configured to generate the machine code modules which contain instructions for the processor. Compiling converts the human readable source code into machine specific object code or instructions. Linking stitches the various machine code modules together into a single piece of executable code, referred to as a board support layer (BSL) 320 and application layer 406. As used herein, board support layer means any machine executable code specifically designed to interface with a specific version, release, model, make, type, or kind of one or more hardware components regardless of the name used to identify this executable code or whether the excutable code is embedded or stored in a separate storage device. Those of skill in the art will recognize that executable code having other names but substantially the same functionality are within this scope of the board support layer as used herein.

The BSL 320 and application layer 406 may then be downloaded to a target embedded system and stored within suitable memory devices of the target embedded system. When the target embedded system is reset or power cycled, the downloaded BSL 320 and application 406 begin executing on the embedded system as the processor reads and executes those stored instructions.

The BSL 320 operates in a manner similar to a Basic Input/Output System (BIOS). The BIOS of a computer system enables communication between an operating system and the hardware of the computer system. Similarly, the BSL 320 enables the communication of embedded, real time, or traditional operating systems to communicate with the hardware components of the embedded system. Beneficially, the BSL 320 of the current embodiment drastically reduces development time of embedded systems due to the automated generation of the BSL 320 by the automation module 210.

The resulting BSL 320 comprises services and protocols configured to allow an operating system to interface with the embedded system. For example, services and protocols may include, but are not limited to, low-level drivers for each hardware component as well as protocol stack layers such as the Transmission Control Protocol/Internet Protocol (TCP/IP), Universal Serial Bus (USB) protocol, IEEE 802.11 b/g Wireless specifications, voice, MODEM, and many other protocol drivers. In a further embodiment, the BSL 320 and application layer 406 includes diagnostic tools from the components library 314. Such diagnostic tools may include modules for testing memory, busses, processors, peripherals, etc.

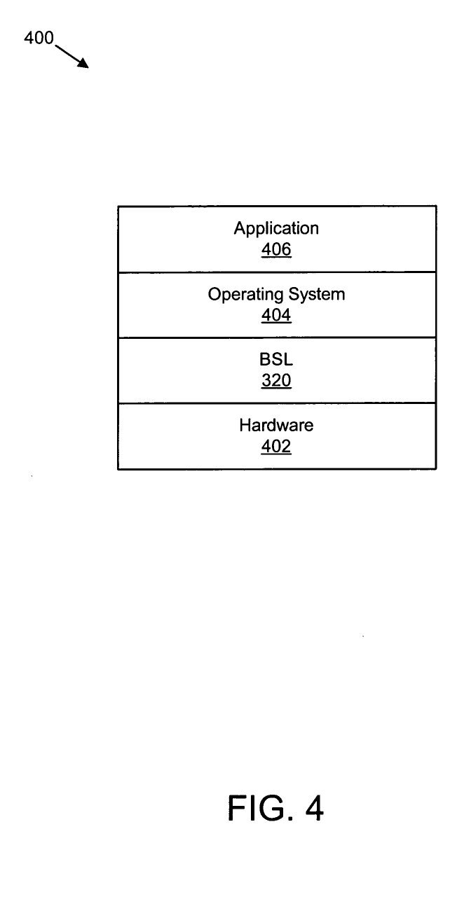

FIG. 4 is a schematic block diagram graphically illustrating representative layers of an embedded system 400. In one embodiment, the embedded system 400 comprises a hardware or board layer 402, the BSL 320, an operating system layer 404, and the application layer 406. The hardware layer 402 may comprise any embedded system having a plurality of hardware components for performing a specific function. Additionally, the hardware layer 402 may be designed to perform multiple functions. The BSL 320 is configured to allow the operating system layer 404 access to a plurality of hardware components within the hardware layer 402. The BSL 320 generated in response to the hardware components requires no further coding and may be operatively coupled to the hardware layer 402. In a further embodiment, the BSL 320 may be installed in a data storage component of the hardware layer 402.

Once the hardware layer 402 is rebooted or power cycled, the BSL 320 initializes the various hardware components of the hardware layer 402, optionally performs low-level hardware testing, and boots the operating system layer 404. In one embodiment, the operating system layer 404 comprises embedded versions of Linux®, or Microsoft Windows®. The operating system layer 404 may alternatively comprise a real time operating system such as Wind River®, VxWorks®, ATI Nucleus®, Wasabi NetBSD®, or the like. The use of such embedded systems and user applications is well known to those skilled in the art and will not be given further discussion herein. As used herein, application layer means a single software application or collection of software applications intended to utilize the hardware components of the hardware layer 402. Examples of applications include, but are not limited to web servers, firewalls, automotive controls, audio/video players, etc.

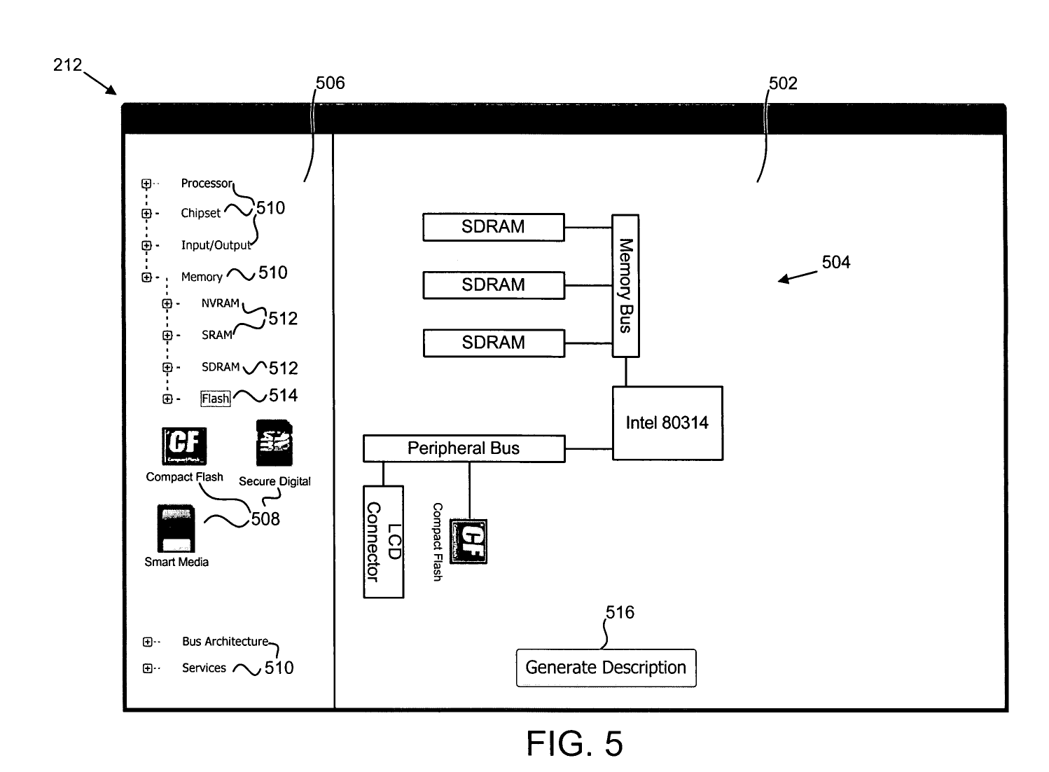

FIG. 5 is a schematic block diagram graphically illustrating one embodiment of the graphical user interface 212 in accordance with the present invention. The graphical user interface 212 may comprise a first window 502 configured to allow a user to logically place and connect hardware components into a hardware map 504. In one embodiment, the graphical user interface 212 also includes a second window 506 configured to display a list of selectable icons 508 or text. In the depicted embodiment, the second window 506 is configured to display a plurality of hardware groups 510 such as, but not limited to, processor, chipset, memory, bus architecture, peripherals and services. Additionally, each hardware group 510 may include a plurality of sub-groups 512. The graphical user interface 212 may be used to create and maintain the hardware description data 303 for various hardware elements, including the hardware layer 402.

Once a group 510 or sub-group 512 has been selected, the second window 506 may display corresponding selectable icons 508. For example, if memory 510 is first selected, then a sub-group flash 514 is selected, the second window 506 may display the illustrated icons 508. The user may then “drag and drop” an icon 508 into the first window 502 and connect the icon 508 to other hardware component icons. Upon building a hardware map 504, a user may select or click on a generate description button 516 and the graphical user interface 212 generates the hardware description data 303 used by the automation module 210 as described above with reference to FIG. 3.

The graphical user interface 212 may be implemented as a program on the client device 102, a plugin, or a webpage running on a server. In a further embodiment, the graphical user interface 212 may be configured to communicate with the server 104 over the Internet 208 in order to extract certain software modules from the libraries 310-318 of the automation module 210. FIG. 5 is given by way of example and illustrates one simple embodiment. Unnecessary features and modules have been omitted for clarity. Those of skill in the art will recognize a number of variations in the graphical user interface 212 that may be more complex or more simple than that described above. Furthermore, conventional methods for communicating the hardware description data 303 and libraries 310-318 may be used.

FIG. 6 is a schematic flow chart diagram illustrating one embodiment of a method 600 for automated generation of the BSL 320 and application layer 406 in accordance with the present invention. The method 600 starts 602 and the embedded system is designed 604 by the user. Designing 604 embedded systems is well known to those skilled in the art and will not be discussed further herein. Once the embedded system has been designed 604, the hardware description data 303 or HDML file is generated. In one embodiment, generating and submitting 606 the HDML file comprises automatically or manually creating hardware description data 303 and transmitting the data 303 to the automation server 110 as described above with reference to FIGS. 2 and 3.

The automation module 210 receives the data and parses 608 the hardware description data 303. In one embodiment, parsing 608 comprises the input module 302 receiving the hardware description data 303. Parsing 608 may also include automatically identifying hardware components and generating hardware description data 303. In one embodiment, the hardware description data 303 may comprise the HDML file. Alternatively, the input module 302 may be configured to receive a text, binary, or third party hardware description data. Additionally, parsing 608 comprises passing the hardware description data 303 to the build module 306. In a further embodiment, the build module 306 may be configured to customize a pregenerated platform library 310. Alternatively, the build module 306 generates 610 the platform library 310.

The modification module 304 then customizes 612 the software by extracting hardware specific software modules from the platform library 310, services library 312, components library 314, executive library 316, and custom library 318. After the modification module 304 extracts the necessary pieces from the plurality of libraries, the compiler 308 links the various extracted software modules and generates 614 the executable BSL 320 and application layer 406. Upon generating 614 the executable, the automation module 210 sends the BSL 320 and application layer 406 to the user. The user may then program 616 and test 618 the embedded system using the generated BSL 320 and application layer 406. If the system functions according to design specifications, then the user has no need to replace 620 hardware components and the method ends 622.

However, the user typically is required to design and build several revisions of the embedded system before achieving a final, customer-ready embedded system. The method 600 beneficially automates the time consuming steps of generating the BSL 320 and application layer 406. If the user finds that a hardware component needs to be replaced 620, a simple modification 604 to the hardware description data 303 or HDML file is all that is required before submitting 606 the hardware description data 303 to the automation module 210. The method 600 then follows to completion as described above.

The automated generation of embedded systems software method 600 is primarily intended for automatically generating a hardware abstraction layer that any application may use. For example, any application, such as a product specific application for a local area network router, may interface with an operating system built on top of the BSL 320.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for automated generation of embedded systems software, the apparatus comprising:
an input module configured to receive hardware description data describing hardware components of an embedded system;
a build module configured to generate an embedded system board support layer in response to the hardware description data for interfacing with the hardware components; and
a compiler module configured to compile the embedded system board support layer into hardware specific executable code.

2. The apparatus of claim 1, wherein the build module is further configured to generate an application layer for interfacing with the hardware components and performing specified functions.

3. The apparatus of claim 1, further comprising a modification module configured to link the embedded system board support layer and at least one component from a plurality of object code libraries to customize the executable code to specific hardware identified in the hardware description data.

4. The apparatus of claim 1, wherein the modification module is configured to extract application specific software modules from predefined libraries.

5. The apparatus of claim 1, wherein the build module is configured to select source code from a platform library having pre-defined source code for hardware level communication with specific hardware identified in the hardware description data.

6. The apparatus of claim 1, further comprising an automation module configured to automatically identify hardware elements of an embedded system and generate hardware description data for the embedded system.

7. The apparatus of claim 1, further comprising a graphical user interface configured to display selectable icons representative of hardware elements from a plurality of hardware element icons, organize the selected icons into a hardware design, and generate hardware description data from the hardware design.

8. The apparatus of claim 1, wherein the input module is configured to generate a hardware description markup language file from the hardware description data.

9. A system for automated generation of embedded systems software, the system comprising:
an automation server coupled to a communications network;
an input module operatively coupled to the automation server and configured to receive hardware description data describing hardware components of an embedded system;
a build module configured to generate an embedded system board support layer in response to the hardware description data for interfacing with the hardware components;
a compiler module configured to compile the embedded system board support layer into executable code; and
a graphical user interface configured to display selectable icons representative of hardware elements from a plurality of hardware element icons, organize the selected icons into a hardware design, and generate hardware description data from the hardware design.

10. The system of claim 8, further comprising a modification module configured to link the embedded system board support layer and at least one component from a plurality of object code libraries to customize the executable code to specific hardware identified in the hardware description data.

11. The system of claim 8, wherein build module is configured to select source code from a platform library having pre-defined source code for hardware level communication with specific hardware identified in the hardware description data

12. The system of claim 8, further comprising an automation module configured to automatically identify hardware elements of an embedded system and generate hardware description data for the embedded system

13. A signal bearing medium tangibly embodying a program of machine-readable instructions executable by a digital processing apparatus to perform operations to automatically generate embedded system software, the operations comprising:
an operation to receive hardware description data describing hardware components of an embedded system;
an operation to generate an embedded system board support layer in response to the hardware description data for interfacing with the hardware components; and
an operation to compile the embedded system board support layer into executable code.

14. The signal bearing medium of claim 12, wherein the instructions further comprise an operation to link the embedded system board support layer and at least one component from a plurality of object code libraries to customize the executable code to specific hardware identified in the hardware description data.

15. The signal bearing medium of claim 12, wherein the instructions further comprise an operation to extract application specific software modules from predefined libraries.

16. The signal bearing medium of claim 12, wherein the instructions further comprise an operation to select source code from a platform library having pre-defined source code for hardware level communication between specific hardware identified in the hardware description data.

17. The signal bearing medium of claim 12, wherein the instructions further comprise an operation to automatically identify hardware elements of an embedded system and generate hardware description data for the embedded system.

18. The signal bearing medium of claim 12, wherein the instructions further comprise an operation to select icons representative of hardware elements from a plurality of hardware element icons, organize the selected icons into a hardware design, and generate hardware description data from the hardware design.

19. The signal bearing medium of claim 12, wherein the instructions further comprise an operation to generate a hardware description markup language file from the hardware description data.

20. A method for automated generation of embedded systems software, the method comprising:
receiving hardware description data describing hardware components of an embedded system;
generating an embedded system board support layer in response to the hardware description data for interfacing with the hardware components; and
compiling the embedded system board support layer into executable code.

21. An apparatus for automated generation of embedded systems software, the apparatus comprising:
means for receiving hardware description data describing hardware components of an embedded system;
means for generating an embedded system board support layer in response to the hardware description data for interfacing with the hardware components; and
means for compiling the embedded system board support layer into executable code.
